(19) United States
(12) Patent Application Publication
(10) Pub. No.: US 2026/0349075 A1
(43) Pub. Date: Nov. 5, 2026

(54) SYSTEM AND METHOD OF INTERFERENCE COORDINATION FOR AUTOMOTIVE RADAR

(71) Applicant: AUMOVIO Germany GmbH, Frankfurt am Main (DE)

(72) Inventors: David GONZALEZ GONZALEZ, Egelsbach, Hessen (DE); Andreas ANDRAE, Friedberg (DE); Osvaldo GONSA, Frankfurt (DE); Mario Schuehler, Effeltrich (DE)

(73) Assignee: AUMOVIO Germany GmbH, Frankfurt am Main (DE)

(21) Appl. No.: 19/484,668

(22) PCT Filed: May 17, 2024
(86) PCT No.: PCT/EP2024/063639

§ 371 Date: Nov. 14, 2025

(30) Foreign Application Priority Data
May 17, 2023 (DE) 102023204640.7

(51) Int. Cl. G01S 7/02; G01S 7/00; G01S 13/931

(52) U.S. Cl. CPC G01S 7/0232; G01S 7/006; G01S 13/931

(57) ABSTRACT

A system of interference coordination for a multitude of automotive radars, each automotive radar defined by its own radar technology, radar features configurable by a processor, and interference suppression capabilities. The system includes a radar management entity adapted to receive, by wireless communication, information from the multitude of automotive radars, and provide, by wireless communication, a domain-defined interference coordination policy. The information received from each automotive radar comprises data about its own radar technology, configurable radar features, and interference suppression capabilities. The domain defining the interference coordination policy is a geo-referenced area populated by the multitude of automotive radars. A method of interference coordination for automotive radars is also disclosed. The method includes receiving radar-related information from automotive radars within the geo-referenced zone; generating, interference coordination policies within the geo-referenced zone, depending on the received radar-related information; transmitting, by wireless communication, the interference coordination policies within the respective geo-referenced zone.

### CROSS REFERENCE TO RELATED APPLICATION

This application is the U.S. National Phase Application of PCT International Application No. PCT/EP2024/063639, filed May 17, 2024, which claims priority to German Patent Application No. 10 2023 204 640.7, filed May 17, 2023, the contents of such applications being incorporated by reference herein.

### FIELD OF THE INVENTION

The present invention relates to a method of operating an automotive radar system for coordination of interference with other radar systems, and to an automotive radar system operable according to such method.

### BACKGROUND OF THE INVENTION

Perception of car surroundings is essential for advanced driver assistance systems (ADAS) and automated driving. Perception systems include radar, lidar, camera, and ultrasound sensors—each of these perception systems having their strengths and weaknesses. Automotive radar is an emergent, robust key technology enabling intelligent and autonomous features and functions in modern vehicles, especially due to its all-weather, day and night capabilities. Still, for automotive radar performance, scaling parameters is not sufficient to maintain the integrity of safety-critical systems. Required advances include signal processing, waveforms and modulation schemes, and interference mitigation.

Mutual interference between automotive radars increases due to the rising density of radars on the road. In contrast to mobile broadband, where the frequency bands, bandwidth, and power spectral density are tightly regulated, the radar waveforms are not. Against this background, interference mitigation is essential, yet difficult to implement, due to radio resources scarcity and safety-related strict requirements on reliability of operation. Nevertheless, an effective radar interference mitigation strategy should have the right balance between complexity and capability of dealing with the interferers.

Abundant scientific literature exists on this topic, which gleaned below:
[1] J. Bechter, C. Sippel and C. Waldschmidt, “Bats-inspired frequency hopping for mitigation of interference between automotive radars,” 2016 IEEE MTT-S International Conference on Microwaves for Intelligent Mobility (ICMIM), San Diego, CA, 2016, pp. 1-4, doi: 10.1109/ICMIM.2016.7533928,
[2] J. Khoury, R. Ramanathan, D. McCloskey, R. Smith and T. Campbell, “RadarMAC: Mitigating Radar Interference in Self-Driving Cars,” 2016 13th Annual IEEE International Conference on Sensing, Communication, and Networking (SECON), London, 2016, pp. 1-9, doi: 10.1109/SAHCN.2016.7733011,
[3] G. Hakobyan, K. Armanious and B. Yang, “Interference-Aware Cognitive Radar: A Remedy to the Automotive Interference Problem,” in IEEE Transactions on Aerospace and Electronic Systems, vol. 56, no. 3, pp. 2326-2339, June 2020, doi: 10.1109/TAES.2019.2947973,
[4] F. Uysal and S. Sanka, “Mitigation of automotive radar interference,” 2018 IEEE Radar Conference (RadarConf 18), Oklahoma City, 2018, pp. 0405-0410, doi: 10.1109/RADAR.2018.8378593,
[5] Aydogdu, C., Keskin, F., Carvajal, G. et al (2021), “Radar Interference Mitigation through Active Coordination”, IEEE National Radar Conference-Proceedings, 2021 May, doi: 10.1109/RadarConf2147009.2021.9455180.

Each of the above are incorporated herein by reference,

As reflected by the cited prior art, the interference caused by other automotive radars negatively affects the functionality of radars by decreasing object detection capability. This problem is more serious than in communication: as stated by [5], the interfering signal is a one-way signal, while the radar signal of interest is a two-way signal; this makes the interfering signal much stronger than the desired radar signal and much more difficult to mitigate. In addition, radar intermittence may lead safety-critical systems to miss targets or to issue false alarms.

Patent literature also discloses interference mitigation techniques in automotive radars. US20220334216, incorporated herein by reference, discloses an apparatus that includes an interference detector configured to detect interference in a radar received (Rx) signal. The interference detector may include an input to receive transmit (Tx) parameter information of a radar Tx signal, wherein the radar Rx signal is based on the radar Tx signal, and a processor configured to determine interference detection information of an interfering signal based on the radar Rx signal and the Tx parameter information. The interference detection information includes one or more signal parameters corresponding to a shape of the interfering signal, and interference level information to indicate a level of noise caused by the interfering signal in the radar Rx signal. US2022345173, incorporated herein by reference, describes a radar signal processing system with a self-interference cancelling function. The mentioned system includes an analog front end (AFE) processor, an analog to digital converter (ADC), an adaptive interference canceller (AIC), and a digital to analog converter (DAC). The AFE processor receives an original input signal and generates an analog input signal. The ADC converts the analog input signal to a digital input signal. The AIC generates a digital interference signal digital interference signal by performing an adaptive interference cancellation process according to the digital input signal. The DAC converts the digital interference signal to an analog interference signal. Finally, the analog interference signal is fed back to the AFE and cancelled from the original input signal in the AFE processor while performing the front-end process, reducing the interference of the static interference from the leaking of a close-by transmitter during the front-end process. EP4071509 A1, incorporated herein by reference, provides a detection signal transmitting method, detection apparatuses, and a storage medium, and belongs to the field of data detection technologies. The method includes determining orientations of fields of view of the detection apparatuses, and selecting one of a plurality of anti-interference parameters as a target anti-interference parameter based on the orientations of the fields of view of the detection apparatuses and according to a predefined rule, where the plurality of anti-interference parameters are determined according to the predefined rule, so that the detection apparatuses transmit detection signals based on the target anti-interference parameter.

Summarizing, interference coordination for automotive radars (ICAR) is difficult because, in contrast to mobile broadband, different technologies (e.g., analog and digital) populate the same spectrum. Non-homogeneous scenarios make ineffective many reception-based techniques. Centralized coordination (transmission-based) should provide good capabilities but requires continuous communication with low latency from or to every single vehicle. Avoidance mechanisms (e.g., transmission-based) plus suppression schemes (reception-based) are quite compatible since both transmission and reception units are typically independent. Related to that aspect, there are several domains where achieving different levels of orthogonality is possible, e.g., polarization domain, time domain, frequency domain, coding domain, space domain.

Therefore, the technical problem to be solved, in this context, is how to enable a distributed interference coordination in automotive radar for heterogeneous scenarios in terms of radar technology that is also compatible with existing reception-based techniques.

### SUMMARY OF THE INVENTION

An aspect of the present invention aims to provide a system of interference coordination for a multitude of automotive radars, and a correspondent method.

According to a first aspect of the invention, there is provided a system of interference coordination for a multitude of automotive radars, each automotive radar being defined by its own radar technology, radar features configurable by means of a processor, and interference suppression capabilities. The system may comprise a radar management entity, namely a data processing component adapted to receive, by means of wireless communication, information from the multitude of automotive radars, and to provide, by means of wireless communication, a domain-defined interference coordination policy. The information received from each automotive radar may comprise data about its own radar technology, the configurable radar features, and the interference suppression capabilities; the domain defining the interference coordination policy may be a geo-referenced area populated by the multitude of automotive radars.

The main advantages of adopting such a system of interference coordination for automotive radars is robustness, versatility, and a relatively low investment.

According to a second aspect of the invention, there is provided a method of interference coordination for automotive radars (ICAR), carried out by a radar management entity within a wireless communication environment, wherein a plurality of automotive radars is deployed or navigating within a geo-referenced zone. The method may comprise the steps of receiving at the radar management entity, by means of wireless communication, radar-related information from automotive radars within the geo-referenced zone, wherein the radar-related information means radar technology, configurable radar features and interference suppression capabilities available at least one of the automotive radars within the geo-referenced domain; generating, by means of the radar management entity, interference coordination policies within the geo-referenced zone, depending on the received radar-related information; transmitting, by means of wireless communication, the interference coordination policies within the respective geo-referenced zone.

The main advantages of adopting such a method of interference coordination for automotive radars is robustness against multipath fading, versatility in terms of radar technologies and relatively simple synchronization processing.

In one embodiment of the method, the geo-referenced zone is an area covered by a V2X service, and the interference coordination policies are provided as part of the V2X service. In another embodiment, the geo-referenced zone is an area covered by one or more wireless communication, referenced as cell or beams coverage area.

In some embodiments, the interference coordination policies are generated for each radar technology such as frequency modulated continuous waveform (FMCW) radar technology or orthogonal frequency-division multiplexing (OFDM) radar technology. In a further embodiment, the interference coordination policy for FMCW radar technology comprises instructions set to configure at least one radar feature selected from a group comprising a modulation scheme, a modulation frequency, a modulation bandwidth, a chirp slope, and a polarization. In yet another embodiment, the interference coordination policy for OFDM radar technology comprises instructions set to configure at least a set of time-frequency-varying radio resources as radar feature.

In yet another embodiment, the respective interference coordination policies are distributed as common information blocks.

In an alternative embodiment, instead of providing interference coordination policies as part of a V2X service, the radar management entity receives location data from on-vehicle means for geo-localization; further on, the radar management entity determine, based on the location data, that the vehicle is within the geo-referenced zone associated with respective interference coordination policies, and communicate, by means of wireless communication, the interference coordination policies within the respective geo-referenced zone.

In yet other embodiment, the method determine, by means of the radar management entity, a dominant radar technology within the geo-referenced zone, and further updating periodically the geo-referenced automotive radar policies by allocating radio resources to the dominant radar technology.

In yet another embodiment featuring a platoon or a swarm of vehicles operating out-of-coverage of a wireless communication network, the automotive radar policies are communicated as part of respective platooning or swarm formation and configuration policies, via direct vehicle-to-vehicle or device-to-device communication.

Further special features and advantages of aspects of the present invention can be taken from the following description of advantageous embodiments by way of the accompanying drawings.

### BRIEF DESCRIPTION OF THE DRAWINGS

FIG. 1 illustrates a scenario wherein a plurality of automotive radars operates within a wireless communication environment, either as radar sensors on-board vehicles or deployed on traffic infrastructure, at least some of the vehicles and some of the traffic infrastructure being able to communicate with wireless communication network,

FIG. 2 presents the same scenario, wherein the plurality of automotive radars is deployed or navigating within geo-referenced zones defining interference coordination domains for automotive radars, according to an aspect of the invention,

FIG. 3 illustrates an embodiment wherein the geo-referenced zones are cell or beams coverage areas,

FIG. 4 presents an embodiment featuring interference coordination policies distributed as common information blocks, according to an aspect of the invention, up to a sub-zone illustrated as “pixel”,

FIG. 5 displays a schematic representation of one embodiment of a cellular network-based coordination among different automotive radar technologies, for example FMCW or OFDM,

FIG. 6 displays an embodiment featuring a platoon of vehicles operating out-of-coverage of a wireless communication network,

FIG. 7 displays an alternative embodiment featuring a swarm of vehicles operating out-of-coverage of a wireless communication network.

### DETAILED DESCRIPTION OF EXEMPLARY EMBODIMENTS

For a better understanding of the principles of the present invention, embodiments of the invention will be explained in more detail below with reference to the figures. Like reference numerals are used in the figures for the same or equivalent elements and are not necessarily described again for each figure. It is to be understood that the invention is not limited to the illustrated embodiments and that the features described may also be combined or modified without departing from the scope of the invention as defined in the appended claims.

As referred to herein, an “automotive radar” include a radar transmitter unit Tx configured to transmit radar waveforms having a radar carrier frequency towards a scene and a radar receiving unit Rx that is configured for receiving radar waveforms that have been transmitted by the radar transmitter unit Tx and have been reflected by a target in the scene. The automotive radar has also means for decoding information from the radar waveforms received by the radar receiving unit Rx. An automotive radar may be stationary (integrated in traffic infrastructure) or mobile (mounted on-board of vehicles, each vehicle being equipped with several radar sensors dedicated to specific driving assisting functions, for example). A “radar technology” employed by an automotive radar is, for example, frequency-modulated continuous-wave (FMCW) radar technology or orthogonal-frequency division multiplexing (OFDM) radar technology, or alternative radar waveforms technology such as pseudo-random—which have been well known for several decades. The term of “interference suppression capabilities” generically means various interference suppression mechanisms employed either at receiving unit Rx or transmitter unit Tx for each automotive radar concerned. An “interference coordination policy” is an encripted, encoded list of rules/instructions of configuring radar features, depending on radar technology and interference suppression capabilities available.

Various embodiments described herein are generally directed to techniques of interference coordination for automotive radars deployed or navigating within a wireless communication environment.

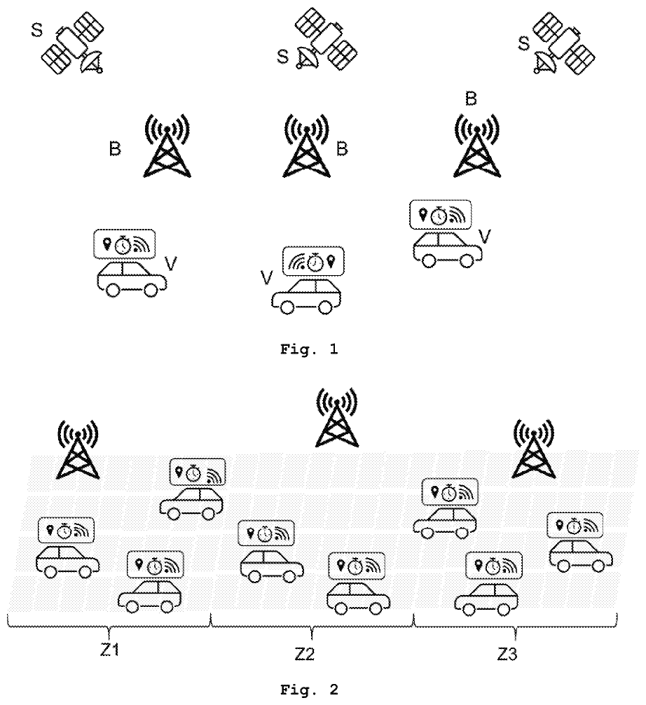

In the following, the exemplary scenario shown in FIG. 1 is used to further explain how operates the system according to an aspect of the invention. FIG. 1 illustrates an exemplary number of vehicles V arbitrarily deployed or navigating within a communication environment, being equipped with on-board means of conventional communication (schematically illustrated, not referenced) such as 4G and/or 5G (cellular) communication capabilities, e.g., Uu or sidelink, able to communicate with mobile communication network S via base stations B. Base stations B may also be integrated in traffic infrastructure, for example, as roadside units on which stationary automotive radars may be mounted in order to monitor traffic in intersections or along roads. In addition, usually vehicles are equipped with on-board means for geo-localization via all global navigation satellite systems (GNSS), such as GPS, Galileo, GLONASS (Russia), Compass (China), IRNSS (India) (by means for geo-localization meaning, for example, a GPS module for providing a GPS time and location). For the exemplification purpose of this description, all illustrated vehicles are assumed to be equipped with means for geo-localization, able to acquire basic or coarse positioning and timing. Further on, at least some of the illustrated vehicles are assumed to be equipped with at least one automotive radar employing one radar technology out of N possible radar technologies, and this at least one automotive radar comprises transmission Tx and reception Rx units—in other words, a multitude of automotive radars, each automotive radar being defined by its own radar technology (FMCW or OFDM, for example), radar features configurable by means of a processor (frequency channel to be switched to, or chirp slopes to be assigned, for example), and interference suppression capabilities. The system according to an aspect of the invention comprises a radar management entity (not illustrated nor referenced), namely a data processing component adapted to receive, by means of wireless communication, information from the multitude of automotive radars, and to provide, by means of wireless communication, a domain-defined interference coordination policy. The information received from each automotive radar comprise data about its own radar technology, the configurable radar features, and the interference suppression capabilities; the domain defining the interference coordination policy is a geo-referenced area populated by the multitude of automotive radars.

FIG. 2 presents the same scenario as in FIG. 1, wherein the plurality of automotive radars is deployed or navigating within geo-referenced zones Z₁, Z₂, Z₃ defining interference coordination domains for automotive radars, according to an aspect of the invention. In an embodiment of the invention, such interference coordination domains (i.e., geo-referenced zones Zi) are arbitrarily defined based on pre-existing vehicle-to-everything (V 2X) zones covered by 4G or 5G communication technologies and dedicated inter-vehicular communication services. These zones are used for other purposes in the context of cellular communications—such as resource allocation (i.e., to indicate the resource pool to be used) in 4G, or to control feedback mechanisms in 5G. Nevertheless, in the context of the present description, the coordinates of such pre-existent zones covered by dedicated V2X services are used as input data by the radar management entity.

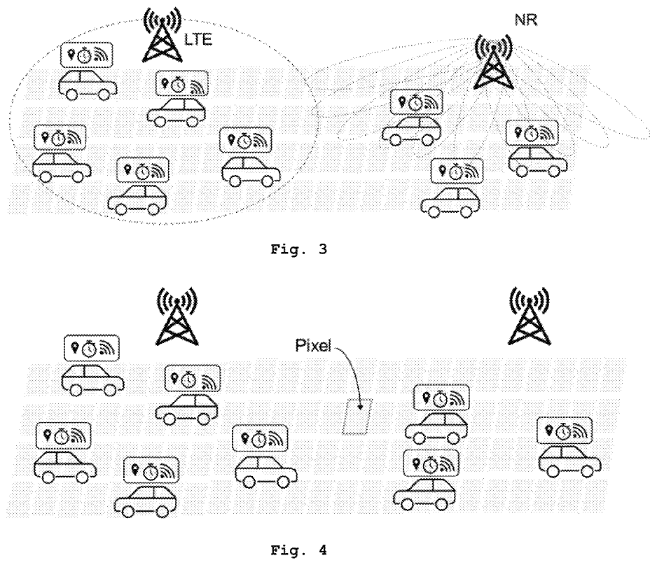

FIG. 3 presents an embodiment of the invention, wherein an interference coordination domain is identified by a coverage area of a mobile communication network, such as cell (e.g., usual for LTE (4G) technology) or a beam (e.g., usual for NR (5G) technology).

FIG. 4 shows another embodiment of the invention, featuring interference coordination policies distributed as common information blocks, according to an aspect of the invention. Once data about the automotive radars within a domain are received by the radar management entity, the radar management entity generates interference coordination policies within the geo-referenced zone named “pixel” in FIG. 4 and defined as i^{th} domain. More precisely, coded, and encrypted interference coordination policies are generated by this radar management entity, to assign as uniformly as possible either orthogonal or non-orthogonal (e.g., NOMA) resources. Examples of how orthogonality is introduced in the context of automotive radars are:
when a configurable radar feature is a radar band composed of M channels, the interference coordination policy allocates a frequency channel_ID to be used for the i^{th} domain Pixel_ID, at a predetermined timing Time_mod_M. This function is expressed by the formula:

Pixel_ID+Time_mod_M=Channel_ID (1)

where timing from GNSS or RAN is used for defining such a policy (TDM-based policy);
when the radar technology is FMCW, the interference coordination policy assigns any of the possible chirp slopes to the geo-referenced zone at a predetermined timing. This function is expressed by the formula:

Pixel_ID+Time_mod_M=Chirp_slope_ID (2)

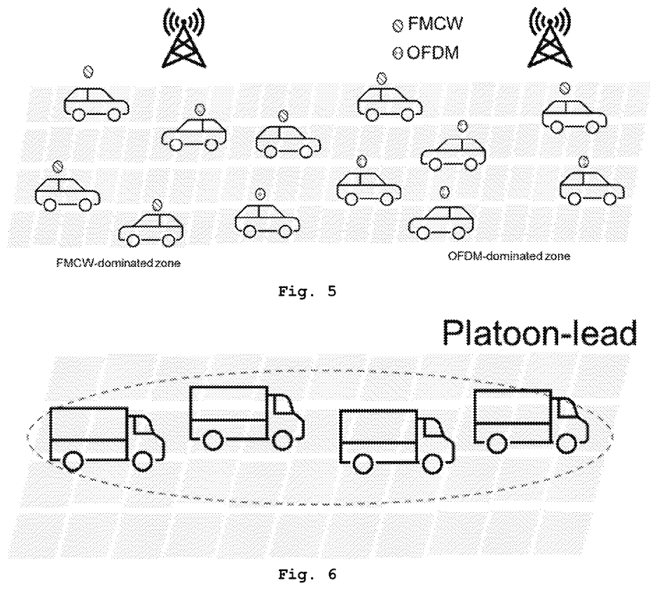

FIG. 5 illustrates another embodiment of a cellular network-based coordination among different automotive radar technologies within one or several geo-referenced zones. When vehicles “register” to an ICAR domain, they indicate essential features of the radar technologies they are equipped with, e.g., radar technology (FMCW, OFDM), interference suppression capabilities etc., by means of one-shot communication. The mobile network uses this information to update policies periodically, e.g., to allocate more orthogonal resources to the radar technology dominant within that ICAR domain (technology-load dependent ICAR policy).

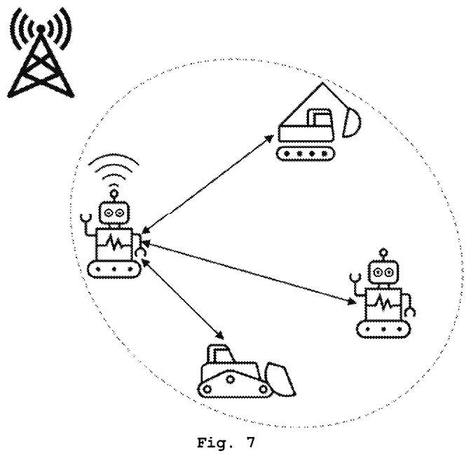

FIG. 6 displays an embodiment of a coordination policy featuring a cluster-based operation (a platoon of vehicles) for an out-of-coverage scenario. Such a scenario requires one-shot V2X communication between platoon vehicles. FIG. 7 displays an alternative embodiment featuring a swarm of tele-operated vehicles, case in which a sidelink-based communication, e.g., broadcast or groupcast, is established vehicles of the swarm to communicate radar-related data in the sense mentioned before in this description (e.g., radar technologies, interference suppression capabilities, etc.). In both embodiments, ICAR policies are distributed and maintained as part of platooning, respective swarm configuration parameters.

The second aspect of the invention is a method of interference coordination for automotive radars (ICAR), carried out by a radar management entity within a wireless communication environment, wherein a plurality of automotive radars is deployed or navigating within a geo-referenced zone Zi. The method comprises the steps of:
S1 receiving at the radar management entity, by means of wireless communication, radar-related information from automotive radars within the geo-referenced zone, wherein the radar-related information means radar technology, configurable radar features and interference suppression capabilities available at least one of the automotive radars within the geo-referenced domain,
S2 generating, by means of the radar management entity, interference coordination policies within the geo-referenced zone, depending on the received radar-related information,
S3 transmitting, by means of wireless communication, the interference coordination policies within the respective geo-referenced zone.

In a first embodiment, the geo-referenced zone is an area covered by a V2X service, and the interference coordination policies are provided as part of the V2X service.

In a second embodiment, the geo-referenced zone is an area covered by one or more wireless communication, referenced as cell or beams coverage area. The wireless communication is cellular technology such as Long-Term Evolution (LTE, 4G) or New Radio (NR, 5G). In an alternative embodiment, instead of providing interference coordination policies as part of a V2X service, the radar management entity receives location data from on-vehicle means for geo-localization; further on, the radar management entity determine, from the location data, that the vehicle is within the geo-referenced zone associated with respective interference coordination policies, and communicate, by means of wireless communication, the interference coordination policies within the respective geo-referenced zone.

In another embodiment, the interference coordination policies are generated for each radar technology such as frequency modulated continuous waveform (FMCW) radar technology or orthogonal frequency-division multiplexing (OFDM) radar technology. For example, the interference coordination policy for FMCW radar technology comprises instructions set to configure at least one radar feature selected from a group comprising a modulation scheme, a modulation frequency, a modulation bandwidth, a chirp slope, and a polarization. The interference coordination policy for OFDM radar technology comprises, for example, instructions configuring at least a time-frequency-varying channel as radar feature. The respective interference coordination policies are distributed as common information blocks.

The method further comprises S4 determining, by means of the radar management entity, a dominant radar technology within the geo-referenced zone, and further updating periodically the geo-referenced automotive radar policies by allocating communication resources to the dominant radar technology.

In case a platoon or a swarm of vehicles operates out-of-coverage, the automotive radar policies are communicated as part of respective platooning or swarm formation and configuration policies, via V2X communication.

However, while certain embodiments of the present invention have been described in detail, those familiar with the art to which this invention relates will recognize various alternative designs and embodiments for practicing the invention as defined by the following claims.

### LIST OF REFERENCE NUMBERS

S—Mobile communication network
B—Infrastructure/base station equipped with automotive radars
V—Vehicles equipped with automotive radars and geo-localization means
Z₁, Z₂, Z₃—geo-referenced zones
Pixel—Sub-zone of geo-referenced zone Z
LTE—Long-Term Evolution
NR—New Radio
FMCW—Frequency Modulated Continuous Waveform radar technology
OFDM—Orthogonal Frequency-Division Multiplexing radar technology

### BIBLIOGRAPHIC REFERENCES

### Non-Patent Literature

[1] J. Bechter, C. Sippel and C. Waldschmidt, “Bats-inspired frequency hopping for mitigation of interference between automotive radars”, 2016, IEEE MTT-S International Conference on Microwaves for Intelligent Mobility (ICMIM), San Diego, CA, 2016, pp. 1-4, doi: 10.1109/ICMIM.2016.7533928
[2] J. Khoury, R. Ramanathan, D. McCloskey, R. Smith and T. Campbell, “RadarMAC: Mitigating Radar Interference in Self-Driving Cars”, 2016, 13th Annual IEEE International Conference on Sensing, Communication, and Networking (SECON), London, 2016, pp. 1-9, doi: 10.1109/SAHCN.2016.7733011
[3] G. Hakobyan, K. Armanious and B. Yang, “Interference-Aware Cognitive Radar: A Remedy to the Automotive Interference Problem”, published in IEEE Transactions on Aerospace and Electronic Systems, vol. 56, no. 3, pp. 2326-2339, June 2020, doi: 10.1109/TAES.2019.2947973
[4] F. Uysal and S. Sanka, “Mitigation of automotive radar interference”, 2018, IEEE Radar Conference (RadarConf 18), Oklahoma City, OK, 2018, pp. 0405-0410, doi: 10.1109/RADAR.2018.8378593
[5] Aydogdu, C., Keskin, F., Carvajal, G. et al (2021), “Radar Interference Mitigation through Active Coordination”, IEEE National Radar Conference—Proceedings, 2021-May, doi: 10.1109/RadarConf2147009.2021.9455180.

### Patent Literature

US 2022334216 A
US 2022345173 A
EP 4071509 B

1. A system of interference coordination for a multitude of automotive radars, each automotive radar being defined by its own radar technology, radar features configurable a by processor, and interference suppression capabilities, the system comprising a radar management entity adapted to receive, by wireless communication, information from the multitude of automotive radars, and to provide, by wireless communication, a domain-defined interference coordination policy,
wherein the information received from each automotive radar comprises data about its own radar technology, the configurable radar features, and the interference suppression capabilities, and wherein the domain defining the interference coordination policy is a geo-referenced area populated by the multitude of automotive radars.

2. A method of interference coordination for automotive radars (ICAR), carried out by a radar management entity within a wireless communication environment, wherein a plurality of automotive radars is deployed or navigating within a geo-referenced zone (Zi), the method comprising the steps of:
receiving at the radar management entity, by wireless communication, radar-related information from automotive radars within the geo-referenced zone, wherein the radar-related information means radar technology, configurable radar features and interference suppression capabilities available at least one of the automotive radars within the geo-referenced domain,
generating, by the radar management entity, interference coordination policies within the geo-referenced zone, depending on the received radar-related information, transmitting, by wireless communication, the interference coordination policies within the respective geo-referenced zone.

3. The method of claim 2, wherein the geo-referenced zone is an area covered by a V2X service, and the interference coordination policies are provided as part of the V2X service.

4. The method of claim 2, wherein the geo-referenced zone is an area covered by one or more wireless communication, referenced as cell or beams coverage area.

5. The method of claim 2, wherein the interference coordination policies are generated for each radar technology such as frequency modulated continuous waveform (FMCW) radar technology or orthogonal frequency-division multiplexing (OFDM) radar technology.

6. The method of claim 5, wherein the interference coordination policy for FMCW radar technology comprises instructions set to configure at least one radar feature selected from a group comprising a modulation scheme, a modulation frequency, a modulation bandwidth, a chirp slope, and a polarization.

7. The method of claim 5, wherein the interference coordination policy for OFDM radar technology comprises instructions configuring at least a time-frequency-varying channel as radar feature.

8. The method according to claim 2, wherein the respective interference coordination policies are distributed as common information blocks.

9. The method according to claim 2, wherein the wireless communication is cellular technology such as Long Term Evolution (LTE, 4G) or New Radio (NR, 5G).

10. The method according to claim 2, comprising: (S4) determining, by the radar management entity, a dominant radar technology within the geo-referenced zone, and further updating periodically the geo-referenced automotive radar policies by allocating communication resources to the dominant radar technology.

11. The method according to claim 2, wherein, instead of providing interference coordination policies as part of a V2X service, the radar management entity receives location data from on-vehicle means for geo-localization,
determine, from the location data, that the vehicle is within the geo-referenced zone associated with respective interference coordination policies, and communicating, by wireless communication, the interference coordination policies within the respective geo-referenced zone.

12. The method according to claim 2, wherein, in case a platoon or a swarm of vehicles operates out-of-coverage, the automotive radar policies are communicated as part of respective platooning or swarm formation and configuration policies, via V2X communication.
